(19) United States
(12) Patent Application Publication
(10) Pub. No.: US 2023/0136117 A1
(43) Pub. Date: May 4, 2023

(54) METHOD OF INTEGRATING TELEPHONE DEVICE AND CONTROLLING ELECTRONIC CONFERENCE

(71) Applicant: Charles Lap San CHAN, Taipei (TW)

(72) Inventor: Charles Lap San CHAN, Taipei (TW)

(21) Appl. No.: 17/973,179

(22) Filed: Oct. 25, 2022

(30) Foreign Application Priority Data
Oct. 29, 2021 (TW) 110140417

(51) Int. Cl. H04L 65/4038; H04L 67/04; H04M 3/56

(52) U.S. Cl. CPC H04L 65/4038; H04L 67/04; H04M 3/563

(57) ABSTRACT

A method of integrating a telephone device and controlling the electronic conference is provided. The method enables the existing telephone device to participate in an electronic conference, the microphone of the telephone device to function as an audio input device, and the speaker of the telephone device to function as an audio output device. With the method of the present invention, the existing telephone device can control the electronic conference without another computer device or electronic device. Therefore, a new application for the existing telephone device is provided.

This application claims priority of Application No. 110140417 filed in Taiwan on 29 Oct. 2021 under 35 U.S.C. § 119; the entire contents of all of which are hereby incorporated by reference.

### BACKGROUND OF THE INVENTION

### Field of the Invention

The present invention relates to a method of controlling an electronic conference, particularly to a method of integrating a telephone device and controlling the electronic conference.

### Description of the Prior Art

In general commercial applications, holding an electronic conference with far-end parties can reduce traffic charges, save the time of calling the conference, and favor real-time intercommunication. With the decrease in electronic equipment cost and increase in network communication speed, electronic conferences have gradually evolved from audio electronic conferences to audiovisual electronic conferences.

The science-technology advances drive individuals or enterprises to update their conference apparatuses. Thus, they may either idle or waste the old conference apparatuses. For example, while the enterprises or individuals intend to replace the telephone devices dedicated to audio electronic conferences with audiovisual electronic conference apparatuses, the old telephone devices for audio electronic conferences would become idle or useless.

Accordingly, the old electronic conference apparatuses confront the problem of being idle or waste because they are replaced in upgrading the old apparatuses or they are unlikely to support new application scenarios. Therefore, how to keep the old conference devices useful or integrate them into the new application scenarios is a problem that the persons in the field are eager to overcome.

### SUMMARY OF THE INVENTION

The primary objective of the present invention is to provide a method of integrating a telephone device system, whereby the original telephone devices are exempted from being idled or wasted but may still be used in electronic conferences.

Another objective of the present invention is to provide a method of integrating a telephone device and controlling the electronic conference, whereby the original telephone device may function as a control platform of an electronic conference.

In order to achieve the abovementioned objectives, the present invention provides a method of integrating a telephone device and controlling the electronic conference, which is executed in an environment of a telephone device, a telephone exchanger, a conference server, and a conference terminal device. The method of the present invention comprises

(A) presenting conference terminal recognition data of the conference terminal device;
(B) operating the telephone device according to the conference terminal recognition data to transmit pairing data to the telephone exchanger;
(C) the telephone exchanger converts the pairing data into a pairing instruction and transmitting the pairing instruction to the conference server;
(D) the conference server pairs the telephone device with the conference terminal device according to the pairing instruction;
(E) the conference server setts the microphone of the telephone device as the audio input device and setting the speaker of the telephone device as the audio output device;
(F) the conference server controls the conference terminal device to log in an electronic conference account of a user according to the pairing instruction;
(G) the conference server transmits conference data of the user to the conference terminal device; and
(H) the conference terminal device outputs the conference data of the user.

The specification of the present invention will disclose some characteristics, advantages, and like items. However, it does not means that any single embodiment of the present invention must involve all the characteristics, advantages, and like items. Although the characteristics, advantages, and like items are described in a specified embodiment, it does not mean that these characteristics, advantages, and like items can only be contained by the same embodiment.

The characteristics and advantages of the present invention will be understood more easily and completely via reading the specification and claims of the present invention and referring to the embodiments and drawings of the present invention.

### BRIEF DESCRIPTION OF THE DRAWINGS

FIG. 1 schematically shows the architecture of a system where a method of integrating a telephone device into an electronic conference is executed according to a first preferred embodiment of the present invention.

FIG. 2 shows a flowchart of a method of integrating a telephone device and controlling the electronic conference according to the first preferred embodiment of the present invention.

FIG. 3 schematically shows a graphic user interface output by a conference terminal device according to a preferred embodiment of the present invention.

FIG. 4 schematically shows the architecture of a system where a method of integrating a telephone device into an electronic conference system is executed according to a second preferred embodiment of the present invention.

FIG. 5 shows a flowchart of a method of integrating a telephone device and controlling the electronic conference according to a second preferred embodiment of the present invention.

### DETAILED DESCRIPTION OF THE INVENTION

In order to explain the disclosed contents more elaborately and completely, the embodiments of the present invention are demonstrated descriptively thereinafter. However, these embodiments are only to exemplify the present invention but not to limit the scope of the present invention. The present invention can also be realized by other embodiments. Each embodiment may involve a plurality of characteristics and steps and a sequence of the steps.

It should be noted that all the functions described in the specification may be executed in hardware or may be software instructions enabling a computer to perform intended operations, except there is another statement. The software instructions may be recorded in a computer-readable medium, such as RAM, a hard disc drive, a flash memory, or another computer-readable medium known by the persons skilled in the art. In some embodiments, the intended operation is executed by a processor, such as a computer. In other embodiments, the intended operation is executed by a programmed integrated circuit according to the program codes in software or firmware. It should be understood: various operations described in the text may be executed by the user manually or automatically executed by the instructions provided or not provided by the user.

The present invention proposes a method of integrating a telephone device and controlling the electronic conference, which can avoid the problem of idling or wasting the original telephone device while the user upgrades the electronic conference apparatus. Further, the method of integrating a telephone device and controlling the electronic conference of the present invention enables the original telephone device to function as a control platform for an electronic conference.

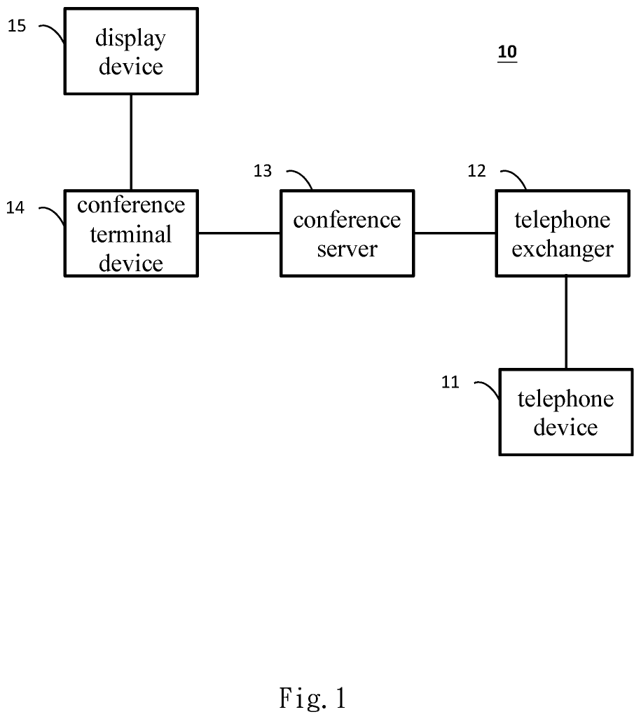

Refer to FIG. 1, which schematically shows a system architecture wherein a telephone device is integrated with an electronic conference system according to a first preferred embodiment of the present invention. Below are introduced the devices and units of an electronic conference system and the functions thereof. The operation process thereof will be described thereinafter. In FIG. 1, a system 10 comprises a telephone device 11, a telephone exchanger 12, a conference server 13, and a conference terminal device 14. The telephone device 11 is in signal connection with the telephone exchanger 12. The telephone exchanger 12 is in signal connection with the conference server 13. The conference server 13 is connected with the conference terminal device 14 in a wired way or a wireless way. A display device 15, which does not belong to the system 10, is connected with the conference terminal device 14 to make the persons in the conference room able to view the images. In the embodiment, the telephone device 11 may be a conventional analog type telephone device, which transmits data to the telephone exchanger 12 in a Dual Tone Multi-Frequency (DTMF) format. The conference terminal device 14 may be a desktop computer or a notebook computer.

In one embodiment, the telephone device 11 allows a user to transmit pairing data to the telephone exchanger 12. The pairing data is used to pair the telephone device 11 with the conference terminal device 14. The details thereof will be described thereinafter. The telephone device 11 also allows the user to transmit conference instruction strings to the telephone exchanger 12, wherein the conference instruction strings will be converted into conference instructions for controlling the electronic conference. The details thereof will also be described thereinafter.

The telephone exchanger 12 is used to convert the pairing data into a pairing instruction and transmit the pairing instruction to the conference server 13. In another embodiment, while the telephone exchanger 12 receives the pairing data and verifies that the pairing data include an extension code, the telephone exchanger 12 performs an Interactive Voice Response (IVR) function to instruct the user to operate the telephone device 11 to input the conference terminal recognition data, a user account, and a user password. Then, the telephone exchanger 12 converts the conference terminal recognition data, the user account, and the user password into the pairing instruction and transmits the pairing instruction to the conference server 13.

The conference server 13 has an electronic conference system. The user may use the user account and the user password to log in the electronic conference system to attend an electronic conference. The conference server 13 may pair the telephone device 11 and the conference terminal device 14 according to the pairing instruction. After the telephone device 11 has been paired with the conference terminal device 14, the conference server 13 set the microphone of the telephone device 11 as an audio input device and set the speaker of the telephone device 11 as an audio output device while the electronic conference is being held. The conference server 13 controls the conference terminal device 14 to log in a user's electronic conference account according to the pairing instruction. Then, the conference server 13 transmits user's conference data to the conference terminal device 14. The conference server 13 also transmits a conference instruction to the conference terminal device 14.

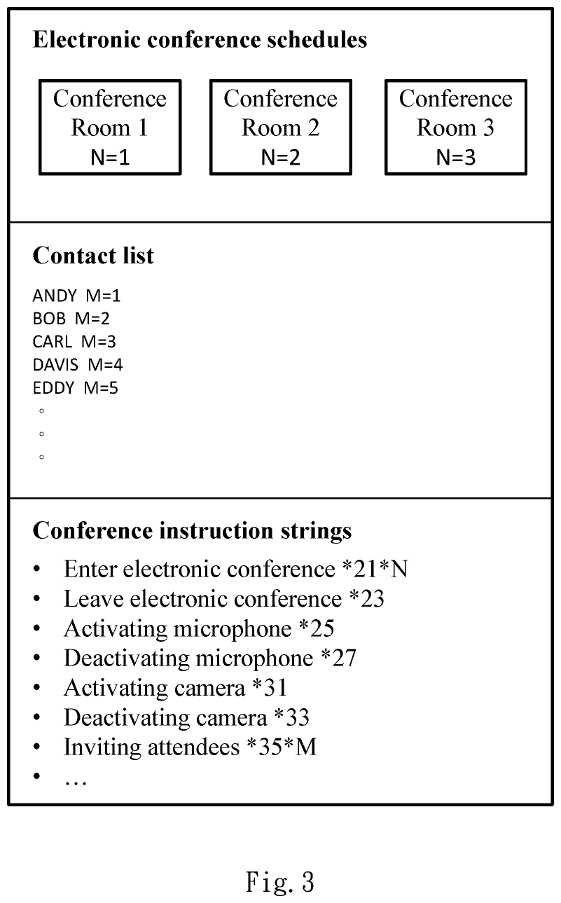

After the conference terminal device 14 is connected with the conference server 13 in a wired or wireless way, the conference terminal device 14 logs in the conference server 13. The conference terminal device 14 presents conference terminal recognition data. For example, the conference terminal device 14 is connected with a display device 15 and outputs to the display device 15 conference terminal recognition data corresponding to the conference terminal device 14. After the conference terminal device 14 logs in the user's electronic conference account, the conference terminal device 14 outputs a graphic user interface (it will be explained while FIG. 3 is mentioned). The graphic user interface shows the user's conference data and a plurality of conference instruction strings, wherein the plurality of conference instruction strings corresponds to a plurality of conference instructions. After the conference terminal device 14 receives the conference instructions from the conference server 13, the conference terminal device 14 controls the electronic conference according to the conference instructions.

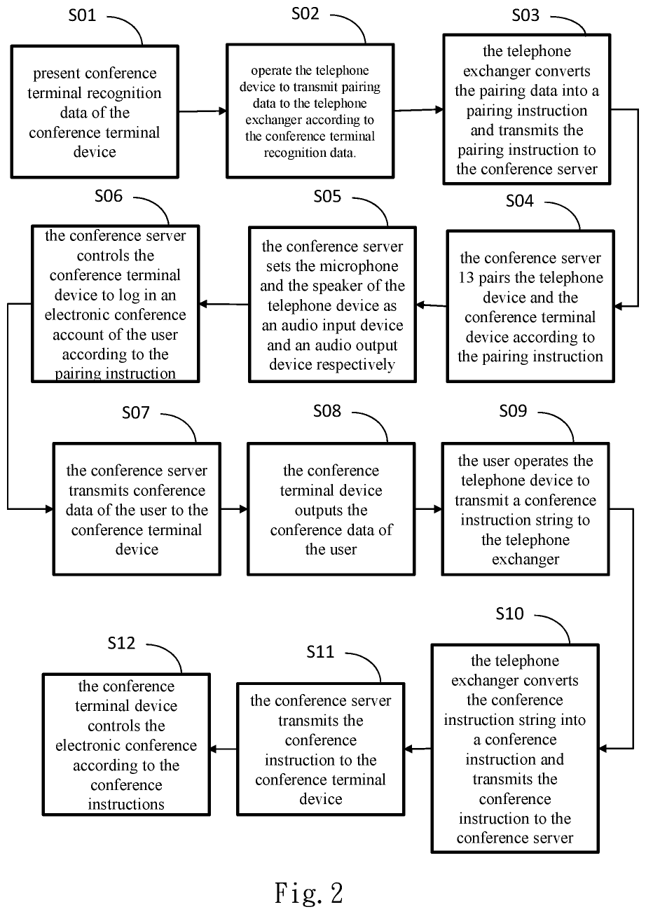

FIG. 2 shows a flowchart of a method of integrating a telephone device and controlling the electronic conference according to the first preferred embodiment of the present invention. Please refer to FIG. 1 and FIG. 2 simultaneously. The application of the devices will be explained in describing the flowchart below. It should be understood that the sequence of the steps may be changed, and some of the steps may be omitted according to requirements.

Firstly, in Step S01, present conference terminal recognition data of the conference terminal device 14. In a conference room, the conference terminal device 14 may be a desktop computer or a notebook computer. In order to make the personnel in the conference room able to view the images clearly, the conference terminal device 14 may be connected with a display device 15. The conference terminal device 14 is registered in the conference server 13 and will present on the display device 15 conference terminal recognition data corresponding to the conference terminal device 14. The conference terminal recognition data may be a string composed of the numerals, letters, and symbols on the keyboard of the telephone device 11, whereby the user may input data with the keyboard of the telephone device 11 while performing the pairing of the telephone device 11 and the conference terminal device 14. For example, the display device 15 presents “*20008100” as the conference terminal recognition data.

In Step S02, operate the telephone device 11 to transmit pairing data to the telephone exchanger 12 according to the conference terminal recognition data. Because the user can see the conference terminal recognition data presented by the display device 15, the user may operate the telephone device 11 to transmit the pairing data to the telephone exchanger 12. In the embodiments of the present invention, the user may input the conference terminal recognition data, the user account, and the user password together with the pairing data, whereby to pair the telephone device 11 and the conference terminal device 14. The user account and the user password are the account and password of a user in an electronic conference system of the conference server 13, respectively. The user account and the user password are used for logging in the electronic conference system to retrieve the conference data of the user. For example, the user account is “*20008080”, and the user password is “*1234”. While the user intends to operate the telephone device 11 to input the conference terminal recognition data, the user account, and the user password simultaneously with the pairing data, “*20008100*20008080*1234” is inputted.

In another embodiment of the present invention, the user may only input an extension code as the pairing data at first. The extension code is used to enable the telephone exchanger 12 to trigger the execution of a special duty, such as the Interactive Voice Response (IVR) function. In one embodiment, the extension code may be “*200”. In the succeeding steps, the user further inputs the conference terminal recognition data, the user account, and the user password. While the telephone exchanger 12 receives the pairing data and verifies that the pairing data include the extension code “*200”, the telephone exchanger 12 performs the IVR service, whereby the user may input the conference terminal recognition data, the user account, and the user password according to the vocal instruction. In the embodiments of the present invention, the telephone device 11 may be a conventional analog-type telephone, which may transmit data to the telephone exchanger 12 in the DTMF format.

In Step S03, the telephone exchanger 12 converts the pairing data into a pairing instruction and transmits the pairing instruction to the conference server 13. As mentioned above, the pairing data is sent to the telephone exchanger 13 by the telephone device 11 in the DTMF format. In order to make the conference server 13 able to receive and process the contents of the pairing data, the telephone exchanger 12 converts the pairing data, which is in the DTMF format, into the pairing instruction and then transmits to the conference server 13 the pairing instruction, which is in a format that can be received and processed by the conference server 13.

In Step S04, the conference server 13 pairs the telephone device 11 and the conference terminal device 14 according to the pairing instruction. The pairing instruction received by the conference server 13 is originated from the telephone device 11, and the pairing instruction includes the conference terminal recognition data, the user account, and the user password. After the account number and password have been successfully verified, the conference server 13 can pair the telephone device 11 with the conference terminal device 14, whereby the operations that the user performs in the telephone device 11 are regarded as the inputs to the conference terminal device 14.

In Step S05, the conference server 13 sets the microphone of the telephone device 11 as an audio input device and sets the speaker of the telephone device 11 as an audio output device. Since the conference server 13 has paired the telephone device 11 with the conference terminal device 14, the conference server 13 may set the microphone of the telephone device 11 as an audio input device of the conference terminal device 14. Thus, it is unnecessary to purchase an additional microphone as the audio input device of the conference terminal device 14 for electronic conferences. In other words, the present invention not only can save money for the user but also can exempt the original telephone device 11 from being idled. Similarly, the conference server 13 sets the speaker of the telephone device 11 as an audio output device of the conference terminal device 14. Thus, it is unnecessary to purchase an additional speaker as the audio output device of the conference terminal device 14 for electronic conferences.

In Step S06, the conference server 13 controls the conference terminal device 14 to log in an electronic conference account of the user according to the pairing instruction. As the pairing instruction received by the conference server 13 includes the account number and password of the electronic conference account of the user, the conference server 13 can control the conference terminal device 14 to log in the electronic conference account of the user.

In Step S07, the conference server 13 transmits conference data of the user to the conference terminal device 14. The conference data of the user includes all the schedules of the electronic conferences of the user and the contact list of the user. However, the present invention does not limit the conference data to only contain the abovementioned data.

In Step S08, the conference terminal device 14 outputs the conference data of the user. As mentioned above, the conference terminal device 14 may be connected with a display device 15 and outputs the conference data of the user to the display device 15, whereby the user and the other attendees in the same conference room can view the images clearly. In one embodiment of the present invention, the conference terminal device 14 may output a graphic user interface, and the graphic user interface may present the conference data of the user and a plurality of conference instruction strings, wherein the plurality of conference instruction strings is respectively corresponding to a plurality of conference instructions. The conference instruction string is composed of the numerals, letters, and symbols on the keyboard of the telephone device 11. In the embodiments of the present invention, the conference instructions may include an electronic conference entering instruction, an electronic conference leaving instruction, an attendee inviting instruction, an attendee quitting instruction, an attendee selecting instruction, a microphone activating instruction, a microphone deactivating instruction, a camera activating instruction, and a camera deactivating instruction. The graphic user interface will be further explained and exemplified thereinafter.

In Step S09, the user operates the telephone device 11 to transmit a conference instruction string to the telephone exchanger 12. As mentioned above, in Steps S01-S08, the telephone device 11 has been successfully paired with the conference terminal device 14; the conference terminal device 14 outputs the conference data of the user; the graphic user interface presents a plurality of conference instruction strings. The user may input corresponding conference instruction strings to perform intended conference operations. For example, while the user intends to enter an electronic conference in Conference Room 1, the user operates the keyboard of the telephone device 11 to input a specified conference instruction string according to the conference instruction string prompted by the graphic user interface, whereby the specified conference instruction string is sent to the telephone exchanger 12 instantly.

In Step S10, the telephone exchanger 12 converts the conference instruction string into a conference instruction and transmits the conference instruction to the conference server 13. As mentioned above, the conference instruction string is sent to the telephone exchanger 13 by the telephone device 11 in the DTMF format. In order to make the conference server 13 able to receive and process the contents of the conference instruction string, the telephone exchanger 12 converts the conference instruction string, which is in the DTMF format, into a conference instruction and then transmits to the conference server 13 the conference instruction, which is in a format that can be received and processed by the conference server 13.

In Step S11, the conference server 13 transmits the conference instruction to the conference terminal device 14. The conference terminal device 14 executes the conference instruction in practice. Therefore, the conference server 13 transmits the conference instruction to the conference terminal device 14.

In Step S12, the conference terminal device 14 controls the electronic conference according to the conference instructions. Suppose the conference instruction string, which the user inputs to the telephone device 11, is “entering the electronic conference in Conference Room 1”. While the conference terminal device 14 receives the conference instruction “entering the electronic conference in Conference Room 1”, which is transmitted by the conference server 13, the conference terminal device 14 enters the electronic conference in Conference Room 1. Suppose the conference instruction string, which the user inputs to the telephone device 11, is “closing the microphone”. While the conference terminal device 14 receives the conference instruction “closing the microphone”, which is transmitted by the conference server 13, the conference terminal device 14 closes the microphone. How the user controls the electronic conference in cooperation with the graphic user interface will be further explained thereinafter.

FIG. 3 schematically shows a graphic user interface output by a conference terminal device according to a preferred embodiment of the present invention. The graphic user interface in FIG. 3 includes the conference data of the user and a plurality of conference instruction strings. The conference data of the user further includes electronic conference schedules and a contact list of the user. As shown in FIG. 3, after the conference server 13 transmits the conference data of a user to the conference terminal device 14 and the conference terminal device 14 outputs the conference data of the user, the user may use the keyboard of the telephone device 11 to input the conference instruction string to perform a special operation of the electronic conference referring to the electronic conference schedules shown in the graphic user interface. Suppose that the user intends to enter Conference Room 1 for an electronic conference. In the graphic user interface, Conference Room 1 is expressed by “N=1”, and the conference instruction string of “entering the electronic conference” is “*21*N”. Thus, the user will enter Conference Room 1 for an electronic conference merely by using the keyboard of the telephone device 11 to input “*21*1”, wherein the last code “1” denotes Conference Room 1. Suppose that the user intends to close the microphone after entering Conference Room 1. The conference instruction string for closing the microphone is “*27”. Thus, the user can close the microphone merely via using the keyboard of the telephone device 11 to input “*27”. Suppose that the user intends to invite Bob in the contact list to enter Conference Room 1 after the user has entered Conference Room 1. In the graphic user interface, Bob is expressed by “M=2”, and the conference instruction string of “inviting a person as an attendee” is “*35*M”. Thus, the user can invite Bob to enter Conference Room 1 merely via using the keyboard of the telephone device 11 to input “*35*2”, wherein the last code “2” denotes Bob. It should be understood that the graphic user interface in FIG. 3 is only for exemplification, and the present invention is not limited by the exemplification.

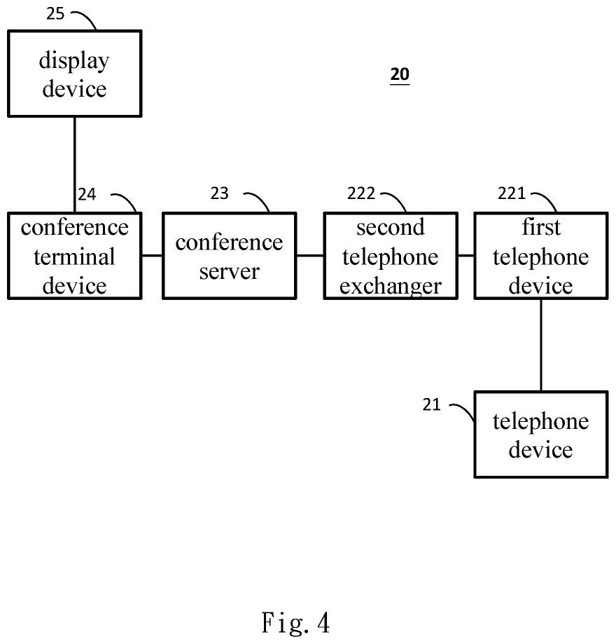

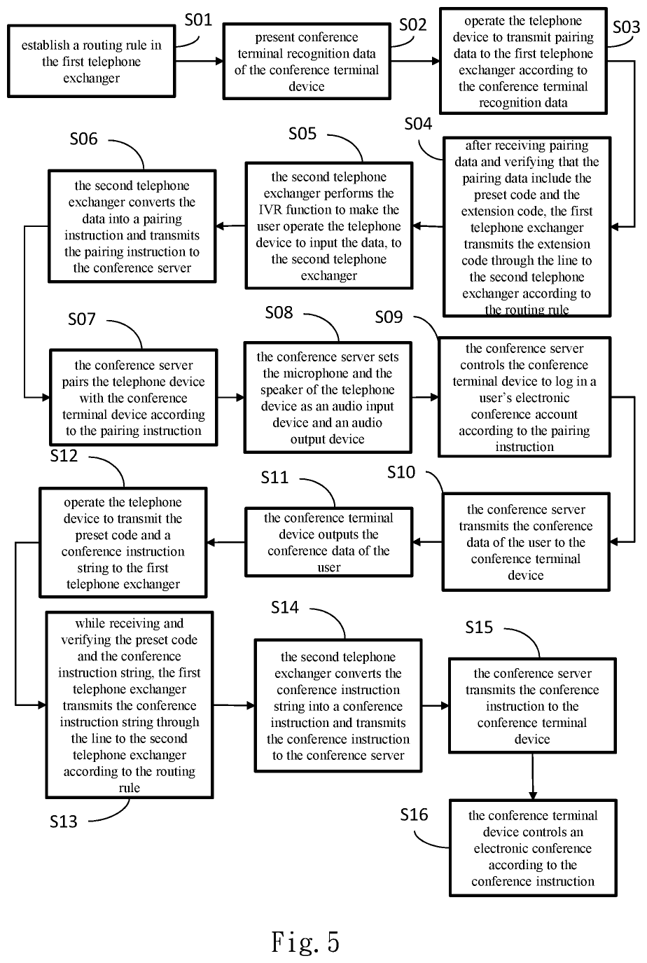

FIG. 4 schematically shows a system architecture wherein a telephone device is integrated with an electronic conference system according to a second preferred embodiment of the present invention. FIG. 5 shows a flowchart of a method of integrating a telephone device and controlling the electronic conference according to the second preferred embodiment of the present invention. In the embodiment shown in FIG. 4 and FIG. 5, a conventional telephone exchanger is integrated into the system of the present invention, wherein the conventional telephone exchanger is unable to convert the data in the DTMF format into the data in the format that the conference server 13 can receive and process. Refer to FIG. 4 and FIG. 5 simultaneously while reading the description of the second preferred embodiment.

In FIG. 4, a system 20 comprises a telephone device 21, a first telephone exchanger 221, a second telephone exchanger 222, a conference server 23, and a conference terminal device 24. The telephone device 21 is in signal connection with the first telephone exchanger 221; the first telephone exchanger 221 is in signal connection with the second telephone exchanger 222; the second telephone exchanger 222 is in signal connection with the conference server 23; the conference server 23 is connected with the conference terminal device 24 in a wired or wireless way. A display device 25, which does not belong to the system 20, is connected with the conference terminal device 24 to make the attendees in the conference room able to view the images. By comparing FIG. 4 with FIG. 1, the function of the telephone device 21 is similar to the function of the telephone device 11; the function of the second telephone exchanger 222 is similar to the function of the telephone exchanger 12; the function of the conference server 23 is similar to the function of the conference server 13; the function of the conference terminal device 24 is similar to the function of the conference terminal device 14. Therefore, the abovementioned devices of the second preferred embodiment will not be described repeatedly herein.

The first telephone exchanger 221 may be a conventional telephone exchanger, which is unable to convert the DTMF-format data into the data that the conference server 23 can receive and process. In order to integrate the first telephone exchanger 221 into the system 20 of the present invention, a routing rule is established in the first telephone exchanger 221. The routing rule includes a preset code and a line. After the first telephone exchanger 221 receives and verifies the preset code, the first telephone exchanger 221 transmits data to the second telephone exchanger 222 via the line. The line is a physical circuit connecting the first telephone exchanger 221 with the second telephone exchanger 222. The operation of the system 20 in FIG. 4 will be further explained thereinafter.

FIG. 5 shows a flowchart of a method of integrating a telephone device and controlling the electronic conference according to the second preferred embodiment of the present invention. Firstly, in Step S10, establish a routing rule in the first telephone exchanger 221. The routing rule includes a preset code (such as *00) and a line. The line is a physical circuit for signal connection between the first telephone exchanger 221 and the second telephone exchanger 222.

In Step S02, present conference terminal recognition data of the conference terminal device 24. The conference terminal device 24 may be a desktop computer or a notebook computer. A display device 25 is connected with the conference terminal device 24 to make the persons in the conference room able to view the images. The conference terminal device 24 is registered in the conference server 23 and will present on the display device 25 conference terminal recognition data corresponding to the conference terminal device 24.

In Step S03, operate the telephone device 21 to transmit pairing data to the first telephone exchanger 221 according to the conference terminal recognition data. The pairing data include a preset code and an extension code. The preset code is to be verified by the first telephone exchanger 221. After the first telephone device 221 has verified the preset code, the first telephone exchanger 221 transmits succeeding data to the second telephone exchanger 222. The extension code is used to make the second telephone exchanger 222 trigger the execution of a special duty, such as an Interactive Voice Response (IVR) function. In one embodiment, the user operates the telephone device 21 to input a preset code “*00” and an extension code “*200”.

In Step S04, after the first telephone exchanger 221 has received pairing data and verified that the pairing data include the preset code “*00” and the extension code “*200”, the first telephone exchanger 221 transmits the extension code “*200” through the line to the second telephone exchanger 222 according to the routing rule.

In Step S05, after receiving the extension code “*200”, the second telephone exchanger 222 performs the IVR function to make the user operate the telephone device 21 to input the conference terminal recognition data, the user account, and the user password to the second telephone exchanger 222.

In Step S06, the second telephone exchanger 222 converts the conference terminal recognition data, the user account, and the user password into a pairing instruction and transmits the pairing instruction to the conference server 23. As mentioned above, the telephone device 21 transmits the conference terminal recognition data, the user account, and the user password in the DTMF format to the second telephone exchanger 222. In order to make the conference server 23 able to receive and process these data, the second telephone exchanger 222 converts the DTMF-format data into the pairing instruction and then transmits the pairing instruction to the conference server 23, wherein the pairing instruction is in a format that the conference server 23 can receive and process.

In Step S07, the conference server 23 pairs the telephone device 21 with the conference terminal device 24 according to the pairing instruction, whereby the operation that the user performs in the telephone device 21 is regarded as the input to the conference terminal device 24.

In Step S08, the conference server 23 sets the microphone of the telephone device 21 as an audio input device and sets the speaker of the telephone device 21 as an audio output device. As mentioned above, as the conference server 23 has paired the telephone device 21 with the conference terminal device 24, the conference server 23 may set the microphone and the speaker of the telephone device 21 as the audio input device and the audio output device, respectively. Thus, it is unnecessary to purchase an additional microphone and an additional speaker as the audio input device and the audio output device. In other words, the present invention can save money for the user and exempt the original telephone device 21 from being idled.

In Step S09, the conference server 23 controls the conference terminal device 24 to log in a user's electronic conference account. As the pairing instruction received by the conference server 23 includes a user account and a user password of an electronic conference account, the conference server 23 can control the conference terminal device 24 to log in the user's electronic conference account.

In Step S10, the conference server 23 transmits the conference data of the user to the conference terminal device 24, wherein the conference data of the user may include the schedule data of all the electronic conferences of the user and the contact list of the user. However, the present invention does not limit the conference data to only the schedule data and the contact list.

In Step S11, the conference terminal device 24 outputs the conference data of the user. As mentioned above, the conference terminal device 24 may be connected with a display device 25 and output the conference data of the user to the display device 25, whereby the user and the other attendees in the same conference room can view the images clearly. The conference terminal device 24 may output a graphic user interface, which presents the conference data of the user and a plurality of conference instruction strings, wherein the plurality of conference instruction strings is respectively corresponding to a plurality of conference instructions.

In Step S12, operate the telephone device 21 to transmit the preset code and a conference instruction string to the first telephone exchanger 221. In Steps S01-S11, the telephone device 21 has been successfully paired with the conference terminal device 14; the conference terminal device 24 outputs the conference data of the user; the graphic user interface presents a plurality of conference instruction strings. Thus, the user may input corresponding conference instruction strings for the intended operations of the electronic conference. In Step S01, the preset code and the line of the routing rule have been established in the first telephone exchanger 221. Therefore, the user can transmit the conference instruction string merely via inputting the preset code and the conference instruction string to the first telephone exchanger 221.

In Step S13, while the first telephone exchanger 221 receives and verifies the preset code and the conference instruction string, the first telephone exchanger 221 transmits the conference instruction string through the line to the second telephone exchanger 222 according to the routing rule.

In Step S14, the second telephone exchanger 222 converts the conference instruction string into a conference instruction and transmits the conference instruction to the conference server 23. As the conference instruction string is transmitted from the telephone device 21 to the first telephone exchanger 221 and then to the second telephone exchanger 222 in the DTMF format, the second telephone exchanger 222 converts the DTMF-format conference instruction string into the conference instruction and transmits the conference instruction to the conference server 23. The conference instruction is a format that the conference server 23 can receive and process.

In Step S15, the conference server 23 transmits the conference instruction to the conference terminal device 24. Because the conference terminal device 24 executes the conference instruction in practice, the conference server 23 transmits the conference instruction to the conference terminal device 24.

In Step S16, the conference terminal device 24 controls an electronic conference according to the conference instruction. If the conference instruction string the user inputs in the telephone device 21 is “entering Conference Room 1 for the electronic conference”, the conference terminal device 24 will receive the conference instruction “entering Conference Room 1 for the electronic conference” transmitted by the conference server 23. Then, the conference terminal device 24 enters Conference Room 1 for the electronic conference. If the conference instruction string the user inputs in the telephone device 21 is “closing the microphone”, the conference terminal device 24 will receive the conference instruction “closing the microphone” transmitted by the conference server 23. Then, the conference terminal device 24 closes the microphone.

In conclusion, the present invention proposes a method of integrating a telephone device and controlling the electronic conference, which can exempt the original telephone device from being idled and wasted while the user upgrades the electronic conference apparatuses. Further, the method of integrating a telephone device and controlling the electronic conference of the present invention enables the original telephone device to function as a control platform of an electronic conference. Besides, the method of integrating a telephone device and controlling the electronic conference of the present invention can integrate a conventional telephone exchanger with another telephone exchanger, whereby the conventional telephone exchanger transmits a DTMF-format data to the another telephone exchanger according to a routing rule, and the another telephone exchanger converts the DTMF-format data into a data having a format that the conference server can receive and process.

The embodiments have been described above to demonstrate the present invention. However, these embodiments are only to exemplify the present invention but not to limit the scope of the present invention. The drawings attached to the specification depict the architectures and configurations of the embodiments to assist in understanding the characteristics and functions of the embodiments. Nevertheless, the present invention is not limited by the characteristics and functions shown in the attached drawings. The characteristics of the present invention may be equivalently replaced by various substitute structures or configurations by the persons having ordinary knowledge in the art without departing from the scope of the present invention. The modification or variation the persons skilled in the art can make easily according to the technical contents of the present invention is to be also included by the scope of the present invention. About the sequences of the flowcharts, operational descriptions, and steps of the method, it should be understood: the embodiments of the present invention are not necessarily realized in the same sequence as that mentioned in the specification except there is another statement.

The embodiments described above are only to exemplify the present invention but not to limit the scope of the present invention. Any equivalent modification or variation made according to the shape, structure, characteristics or spirit disclosed by the present invention is to be also included by the scope of the present invention.

What is claimed is:

1. A method of integrating a telephone device and controlling the electronic conference, and the method operating in an environment of the telephone device, a telephone exchanger, a conference server, and a conference terminal device and comprising:
(A) presenting conference terminal recognition data of the conference terminal device;
(B) operating the telephone device to transmit pairing data to the telephone exchanger according to the conference terminal recognition data;
(C) the telephone exchanger converting the pairing data into a pairing instruction and transmitting the pairing instruction to the conference server;
(D) the conference server pairing the telephone device with the conference terminal device according to the pairing instruction;
(E) the conference server setting a microphone of the telephone device as an audio input device and setting a speaker of the telephone device as an audio output device;
(F) the conference server controlling the conference terminal device to log in an electronic conference account of a user according to the pairing instruction;
(G) the conference server transmitting conference data of the user to the conference terminal device; and
(H) the conference terminal device outputting the conference data of the user.

2. The method of integrating a telephone device and controlling the electronic conference according to claim 1, wherein in step (H), the conference terminal device outputs a graphic user interface; the graphic user interface presents the conference data of the user and a plurality of conference instruction strings; the plurality of conference instruction strings is respectively corresponding to a plurality of conference instructions.

3. The method of integrating a telephone device and controlling the electronic conference according to claim 2, wherein each of the plurality of conference instruction strings is composed of numerals, letters, and symbols of a keyboard of the telephone device.

4. The method of integrating a telephone device and controlling the electronic conference according to claim 2, wherein the plurality of conference instructions includes an electronic conference entering instruction, an electronic conference leaving instruction, an attendee inviting instruction, an attendee quitting instruction, an attendee selecting instruction, a microphone activating instruction, a microphone deactivating instruction, a camera activating instruction, and a camera deactivating instruction.

5. The method of integrating a telephone device and controlling the electronic conference according to claim 1, further comprising:
(I) operating the telephone device to transmit a conference instruction string to the telephone exchanger;
(J) the telephone exchanger converts the conference instruction string into a conference instruction and transmitting the conference instruction to the conference server;
(K) the conference server transmits the conference instruction to the conference terminal device; and
(L) the conference terminal device controls an electronic conference according to the conference instruction.

6. The method of integrating a telephone device and controlling the electronic conference according to claim 1, wherein the pairing data include the conference terminal recognition data, a user account, and a user password.

7. The method of integrating a telephone device and controlling the electronic conference according to claim 1, wherein the pairing data include an extension code.

8. The method of integrating a telephone device and controlling the electronic conference according to claim 7, wherein in step (C), after the telephone exchanger has received and verified the extension code, the telephone exchanger performs Interactive Voice Response (IVR) to make the user operate the telephone device to input the conference terminal recognition data, a user account, and a user password; and the telephone exchanger converts the conference terminal recognition data, the user account, and the user password to function as the pairing instruction.

9. The method of integrating a telephone device and controlling the electronic conference according to claim 1, wherein in step (B), the telephone device transmits the pairing data format to the telephone exchanger in a Dual Tone Multi-Frequency (DTMF).

10. A method of integrating a telephone device and controlling the electronic conference, and the method operating in an environment of the telephone device, a first telephone exchanger, a second telephone exchanger, a conference server, and a conference terminal device and comprising:
(A) establishing a routing rule in the first telephone exchanger, wherein the routing rule includes a preset code and a line, and the line connects the first telephone exchanger with the second telephone exchanger;
(B) presenting conference terminal recognition data of the conference terminal device;
(C) operating the telephone device to transmit pairing data to the first telephone exchanger according to the conference terminal recognition data, wherein the pairing data include the preset code and an extension code;
(D) the first telephone exchanger transmits the extension code through the line to the second telephone exchange according to the routing rule after the first telephone exchanger has received and verified the pairing data including the preset code and the extension code;
(E) the second telephone exchanger performs Interactive Voice Response (IVR) to make a user operate the telephone device to input the conference terminal recognition data, a user account, and a user password to the second telephone exchanger;
(F) the second telephone exchanger converts the conference terminal recognition data, the user account, and the user password into a pairing instruction and transmitting the pairing instruction to the conference server;
(G) the conference server pairs the telephone device with the conference terminal device according to the pairing instruction;
(H) the conference server sets a microphone of the telephone device as an audio input device and setting a speaker of the telephone device as an audio output device;
(I) the conference server controls the conference terminal device to log in an electronic conference account of the user according to the pairing instruction;
(J) the conference server transmits conference data of the user to the conference terminal device;
(K) the conference terminal device outputs the conference data of the user;
(L) operating the telephone device to transmit the preset code and a conference instruction string to the first telephone exchanger;
(M) the first telephone exchanger transmits the conference instruction string through the line to the second telephone exchanger according to the routing rule after the first telephone exchanger has received and verified the preset code and the conference instruction string;
(N) the second telephone exchanger converts the conference instruction string into a conference instruction and transmitting the conference instruction to the conference server;
(O) the conference server transmits the conference instruction to the conference terminal device; and
(P) the conference terminal device controls an electronic conference according to the conference instruction.
